(19) United States
(12) Patent Application Publication
(10) Pub. No.: US 2011/0140913 A1
(43) Pub. Date: Jun. 16, 2011

(54) Multifunctional telemetry alert safety system (MTASS)

(76) Inventor: John Matthew Montenero, Moraga, CA (US)

(21) Appl. No.: 12/590,920

(22) Filed: Nov. 17, 2009

Related U.S. Application Data
(63) Continuation-in-part of application No. 12/286,210, filed on Sep. 29, 2008.

(51) Int. Cl. H04Q 9/00

(52) U.S. Cl. 340/870.07

(57) ABSTRACT

A Continuation-in-Part (CIP) of application Ser. No. 12/286,210 for the system of the present invention “Multifunctional Telemetry Alert Safety System” or “MTASS”, which comprises a personnel accountability and situational awareness monitoring communications system for hazardous work personnel that comprises wireless network-adaptable sensoring-monitoring devices, peripherals and base station dashboard software for telemetry monitoring of real-time information at a plurality of personnel accountability and situational awareness parameters of critical data about the safety, health and whereabouts of hazardous workers deployed in typically dangerous environments. Exterior worker management for urban/wildland firefighting, paramedics, search & rescue, hazmat, coal mines, oil platforms, law enforcement, and other hazardous work, achieve real-time command view and control over a variety, of personnel accountability and safety parameters during work activities of personnel wearing the system of the present invention portable device while operating within the mobile ad hoc wireless network. The portable device is a multi-functional sensing and communicating integration of technologies consolidated into one portable, telemetry device. The portable device's multifunctional integrated technology includes the monitoring, telemetry and alert notification of accountability identification, location, assignment notification, vital signs, ambient vicinity temperature, breathing apparatus status, combustible gas sensing, video streaming, “evacuation” recall signaling, signal tracking and multi-alarm signaling if the wearer has either low remaining air pressure/time, impending thermal breakthrough, low battery power, exceed the safety threshold for safe heart rate or external body temperature readings, or becomes motionless for a predetermined time period, or manually signals for help.

### DETAIL DESCRIPTION (SPECIFICATIONS) OF THE SYSTEM OF THE PRESENT INVENTION “MTASS”

A Continuation-in-Part (CIP) of application Ser. No. 12/286,210 for the system of the present invention “Multifunctional Telemetry Alert Safety System” or “MTASS”, which comprises a plurality of integrated accountability and situational awareness parameters. These parameters monitor and collect data from modularly interfaced and integrated technologies and associated wireless body area network (WBAN) peripherals communicating by coded transmissions via IEEE 802.xx radio technology (i.e. IEEE 802.15.4 ZigBee). Then collected data is processed through the system of the present invention's portable device's electronic technology. Data collected from all sensing modules is processed to the portable device's main board and communicated through secured PIN-coded telemetry packets processed in intervals out through the portable device's configurable wireless network interface card module for transmitting over a variety of configurable wireless mobile networks, such as any 802.xx (i.e. IEEE 802.15.4 ZigBee, 802.11a/b/g(n) WiFi, 802.16e WiMAX/WiBRO, 802.20 MBWA, 3G/4G UMTS/CDMA2000), or other mobile and/or fixed Wide Area or Metro Area Network communications system. The telemetry from monitoring MTASS portable devices is received to onsite wireless mobile command base station(s) (any portable computer server running the system of the present invention's software or other accommodating software programs) and the agency's Central Command or management running such software and CAD systems. The MTASS base station Personnel Accountability Management System (PAMS) software program or other accommodating software translates PIN-coded telemetry packet transmissions received from monitoring MTASS portable devices. These PIN codes are validated/authenticated and matched with personnel listings of the PAMS software database, previously downloaded from a public safety agency's CAD-type system or is manually programmed. Then the Pin coded packets of software-translated information populates onto PAMS “dashboard” or other accommodating software program and data logs the streaming telemetry, which enables incident command to remotely monitor and record real-time data and even recall recorded stored data transmitted from monitoring MTASS portable telemetry devices of first responders deployed within the wireless network of an incident scene. In mesh wide area or metropolitan area network environments, central command can monitor multiple incidences of multiple monitoring MTASS portable devices deployed within a given region

The system of the present invention MTASS is multi-functionally integrated, wherein each portable device includes a main motherboard interface to communicate with, process data from, and provide power to the various interfacing modular form factor technology modules and both a digital 7-segment 4-character alphanumeric LED display or may be in the form of a liquid crystal display (LCD) and a LED signal strength bar indicator lamp. The MTASS motherboard interface is a personal device computer with an IC micro controller unit to process collected data for telemetry from interfacing technology modules to a modem-type interface module/card. The motherboard Interface has a plug-in EEPROM firmware chip set that is re-programmable for customized device driver applications and PIN-codes, as for example the type of wireless network interface card to be used. A dedicated firmware IC chip and small red switch button next to the LED display at the top of the MTASS portable device provides for single click programming of location assignment by codes that temporarily display during programming. The main interface motherboard Interface receives and provides power to integrated technologies from a prismatic Li-Ion rechargeable battery as the portable device's power source. The motherboard interface monitors the battery and provides a low battery alarm reading with 15 minutes operating time remaining, triggering an audible ‘tick’ sound and an alarm indicator warning that flashes “LOBA” on the portable device's LED display. With the MTASS portable device securely attached to a first responders' vehicle stored breathing apparatus (BA) system, or stationed turnout coat, or stored in a vehicle mounted device rack, it is automatically activated (ON) once the power-charger plug-switch is disconnected, placing the portable device in ‘sensing’ (active) mode. When automatically activated or turned “ON”, the operational signal is heard and a momentary visual signal of the module's internal LED strips flash in a sequence to indicate the unit is in the “Sensing” mode (ON). The MTASS portable device is deactivated (OFF) once the power-charger plug-switch is reconnected to the MTASS portable telemetry device, thereby returning the unit to the ‘Storage/Charging’ position, or the wearer can press and hold down both side buttons simultaneously for 3+ seconds to turn off the device.

The system of the present invention MTASS is multi-functionally integrated, wherein each portable device includes integrated motionless sensing (PASS-type) technology (Module 1). The Motion Monitoring technology has solid-state, non-position sensitive technology to sense a broad range of motion. The motion detection technology provides an input signal indicating whether the first responder is moving. The microprocessor samples the motion detection periodically to determine whether the person is physically inactive for a predetermined time table violation period (e.g. 18 to 35 seconds), and activates a ‘pre-alarm’ mode if this time period is ever exceeded. In the ‘Pre-Alarm’ mode a progressive audible ‘Pre-Alert’ signal annunciates with flashing and is accompanied by the intermittent pulsing of LED strip. The longer the unit is in ‘Pre-Alarm’, the louder the sweeping ‘Pre-Alarm’ signal becomes, signifying that the unit is closer to the full ‘Alarm’ mode. A second alarm is activated if the inactivity period exceeds a second predetermined time limit, e.g. 35 seconds. When in full ‘Alarm’ the ‘Pre-Alarm’ is replaced by the constant rapid pulsing of LED strip accompanied by a loud audible ‘Alarm’ signal that rapidly varies in pitch. Status of motion detection modes (passive, pre-alarm and alarm status) are processed by a microprocessor and continually sent to the interface motherboard Interface for central processing where data packets are tagged with a 4-digit PIN-code for telemetry transmission to any monitoring mobile base station console running the MTASS software program. The motion monitored telemetry received is displayed on the MTASS software dashboard in color and alpha-coded cells: green “OK” in passive state, yellow “PA” in pre-alarm state, red “DN” for down personnel, red “MA” for manual alarm signal. The PIN-coded message is sent in predetermined intervals (i.e. 10 or 15 seconds) through the wireless network interface card module and wirelessly broadcasted over the Portable Mobile Area Network to a nearby command base station system software. While in the passive mode of monitoring (sensing) motion, the portable device's Manual Alarm Bar, located on the upper front face of the portable device, illuminates a steady green, but can be manually put into “Alarm” condition at any time by depressing the alarm bar. This will place the portable device into full alarm mode, switching the manual alarm bar color from passive green to a flashing red light and sounding an audible alarm, while also messaging a data signal to the base station console indicating an emergency or alarm condition on the software dashboard. Once placed into Manual Alarm the portable device processes the alarm message from the motion monitoring module through the interface motherboard Interface as a PIN-coded message to the network interface module for immediate broadcasting as an alarm telemetry message out over the portable mobile area network. There is a wireless, remote, secondary, combination PASS/Manual Alarm-Receiver, either integrated into the MTASS wireless Air Tank Transmitter attached to a breathing apparatus or as a separate peripheral device unit, as described in Section-10, to receive and audibly sound at 95 dB from the backside or rear of the system wearer from the associated alarming MTASS device incase the wearer is laying face-down muffling the sound. While monitoring in the automatic detection alarm mode, first responders receive alarm warnings by both visual and audible means. Visual alarm warnings are by way of high intensity LEDs strips installed on the motion monitoring module illuminating the portable device's translucent case window edging during alarm modes. These LEDs strobe, flash and pulsate indicating motionless states of pre-alert and alarm modes. Audible alarm warnings are by way of dual resonating sound ports producing a 95-1-dBA sound signature designed to generate multiple tones that sweep through a range of 500-4000 Hz with momentary pauses every 4 seconds, allowing the portable device to be audibly identified and tracked. The alarms can be deactivated by depressing the side reset buttons. After an alarm condition, activating the “Reset” button feature automatically messages the base station PAMS program with a green “OK” indicator signal on the associated line “recall” button, whereby advising the base station that the alarm condition of the identified wearer has been addressed. Motion alarm telemetry received by the base station software is interpreted as a flashing ‘red’ cell and alpha-code in the respective data point column and line for thermal temperature readout of the identified portable device wearer.

The MTASS Motion Monitoring Module technology also comprises motionless alarm tracking whereby any motionless or manual alarm message broadcasted from any one MTASS portable device will be received by all other active devices within the network coverage area. When a portable device enters ‘full’ motionless and manual alarm modes, multiple portable devices comprise a method of wirelessly receiving and transmitting alarm and search message radio signals between monitoring portable devices over the deployed mobile area network. Both alarm-targeted and search-targeting messages broadcast by way of a plurality of spaced spread spectrum radio frequency transceivers to permit the location of the targeted portable device to be rapidly measured for location determination to assist respondents in directional location of downed personnel. While in tracking-mode, each monitoring portable device enters into an audible-only alarm mode and the portable device display will override any current display modes to display a fluctuating signal-strength bar meter, not to be confused with the network signal bar indicator lamp, indicating distance from the alarm message signal strength—decreasing in the number of illuminated bars in weaker signaling of greater distance and increasing the number of illuminated bars for stronger signals in lesser distance, having a fully illuminated bar meter once signal target is fully acquired at immediate range of 0 meters distance.

The MTASS Motion Monitoring Module also comprises an integrated rugged resistance temperature detector type sensor technology to monitor the ambient temperature of the surrounding environment to provide first responders with accurate feedback of the environmental temperature. Information regarding temperature in the ambient environment is provided by an analog signal to be converted by analog-to-digital converter into a digital signal for processing by the microprocessor. The temperature information can be processed, using algorithms to anticipate “break through” of excess thermal energy through the first responder's protective suit. When the first responder exceeds a predetermined time weighted average temperature threshold, the audible heat alarm is activated. The resistance temperature detector type sensor technology accurately senses temperature readings up to 1,000° F. or 538° C. The integrated chip set processes collected temperature data to measure pre-determine temperature thresholds for alarm mode activation. An audible warning is activated and temperature reading flashes on the display when first responders are exposed to potentially dangerous temperatures. The temperature readout can be displayed in Centigrade or Fahrenheit. A time-weighted average of heat exposure activates the audible heat alarm and flashing temperature reading on the portable device display when the environmental conditions reach predetermined levels.

Thermal Temperature Sensing approximated alarm reaction times:

| Ambient Temperature | Alarm Reaction Time |
|---|---|
| 150° F. or 66° C. . . . | 14 Minutes |
| 200° F. or 93° C. . . . | 12 Minutes |
| 250° F. or 121° C. . . . | 10 Minutes |
| 300° F. or 149° C. . . . | 8 Minutes |
| 350° F. or 177° C. . . . | 6 Minutes |

Alarm reaction times listed are approximated due to the variance of environmental factors and the thermal inertia of the heat sensing system.

Temperature modes are sent to the interface motherboard interface for telemetry processing over the MANet and to display temperature readings on the system of the present invention's base station console software dashboard program. Temperature alarm telemetry received by the base station software is interpreted as a flashing ‘red’ cell in the respective data point column and line for thermal temperature readout of the identified portable device wearer. The thermal temperature audible alarm can be deactivated by depressing the side “Reset” buttons. After an alarm condition, activating the “Reset” button feature automatically messages the base station PAMS program with a green “OK” indicator signal on the associated line “recall” button, whereby advising the base station that the alarm condition of the identified wearer has been addressed.

The MTASS Motion Monitoring Module technology also automatically records a data-log of all motion monitored status change events. The data-log is stored in non-volatile memory and can be retrieved via an internal fire wire port on the portable device by utilizing data-log retrieval software. Data-logged events are time and date stamped down to 1 second resolution of the last 8000 stored events. In back up to the system telemetry, the Motion Monitoring Module automatically records a data-log of all motion status change events. The data-log is stored in non-volatile memory that can be retrieved by opening the portable device to access the internal firewire port on the motion monitoring module or motherboard. The required data-log events are time and date stamped down to 1 second resolution, storing up to approx. the last 8,000 events. The motion monitor module is powered by the portable device's onboard prismatic Li-Ion rechargeable battery via the motherboard interface.

The system of the present invention MTASS is also multi-functionally integrated, wherein each portable device includes an integrated confined space multi-gas monitoring module (Module 2). The multi-gas monitoring module sends an environmental signal alert that is representative of gas type and levels present in the air surrounding the wearer of said portable device. The multi-gas monitor module comprises 3 gas sensors for sensing the present levels of oxygen, combustible and toxic gases, which in alarm mode sounds a loud (95 dBA) series of audio alert tones; and a visual LED alerts from flashing “yellow” and “red” LED alarm lights to warn if any dangerous levels of gases or vapors are present at the monitoring portable device. Also the portable device's LED display will flash gas type or NFPA 704 code. Alarms are transmitted as an alarm signal to the main controller unit for processing and sent out through the portable device's configured wireless network interface card module for broadcast over the MANet. Sensing status is sent through the system of the present invention for telemetry processing over the MANet to display status on the system of the present invention's base station console PAMS software dashboard program. The data is interpreted by the software on the dashboard as a steady ‘green’ cell indicator and reading of any low-level presence of gas type indicated as non-alarm gas status, and a blinking ‘yellow’ or “red” cell indicator with the appropriate NFPA 704 Hazard Code and gas type to indicate a dangerous presence of gas alarm. Incident command can send an ‘EVAC’ signal from the base station software to the gas alarming portable device to recall or warn the wearer if no reset signal is received in a timely manner. The gas alarm can be deactivated by depressing the side “Reset” buttons to turn off the alarm. After an alarm condition, activating the “Reset” button feature automatically messages the base station PAMS program with a green “OK” indicator signal on the associated line “Recall” button, whereby advising the base station that the alarm condition of the identified wearer has been addressed. Once the gas sensor is cleared of gas detection, the telemetry signal reverts back to a passive state of signal telemetry to the base station software program that interprets a ‘green’ illuminated cell indicator of a return to neutral or passive status. The multi-gas monitor module is powered by the portable device's onboard prismatic Li-Ion rechargeable battery via the motherboard interface.

The system of the present invention MTASS is also multi-functionally integrated, wherein each portable device includes a multifunctional wireless personal area network (WPAN) module (Module 3) and an assigned Wireless Biotelemetry Monitoring Transmitter that serves as a peripheral device part of the system of the present invention. The WPAN module comprises 802.15.4 ZigBee wireless technology with programmable firmware via an external Infra0Red (IR) port to computer connectivity. The ZigBee provides communication with not only the MTASS Wireless Body Area Network (WBAN) Biotelemetry Monitoring Transmitter for heart rate monitoring (HRM) and dermal temperature monitoring (DTM), but also with other wireless peripherals—such as MTASS wireless air tank coded-transmitter, streaming video and photos from wireless transmitting OEM thermal imagers and helmet cameras. The system of the present invention's WBAN Biotelemetry and Air Tank Peripheral Coded-Transmitter devices and applicable OEM peripheral devices having a signal emitter generating device, generate a unique identification signal that is characteristic of the transmitter. The peripheral transmitter's coded identification signal is programmed into the MTASS WPAN module where it is received and tested. If the identification signal matches an identification comparison signal stored in the monitoring portable device's WPAN programmable firmware, data is accepted and processed through the motherboard interface's microcontroller unit. WPAN telemetry data sent to the motherboard interface for telemetry processing is transmitted over the MANet to display readings on the system of the present invention MTASS's base station console software dashboard program. The WPAN module is powered by the portable device's onboard prismatic Li-Ion rechargeable battery via its motherboard interface.

For biotelemetry monitoring, the system of the present invention's base station software includes a dashboard readout of numeric data for HRM beats per minute (bpm) and dermal (skin) temperature. The software program also provides for a biotelemetry alarm program whereby biotelemetry received from a given monitoring portable device(s) is processed against a time-weighted measure of pre-determine heart rate beats-per-minute (bpm) and dermal temperature thresholds for alarm mode activation for both excessive high heart rate and dermal temperature time readings. Both heart rate monitoring (HRM) & dermal temperature monitoring (DTM) biotelemetry are displayed as numeric values in the respective line-column cells of the MTASS software control system dashboard. Any biotelemetric alarms that are determined by the MTASS software program appear as a flashing ‘red’ illuminated cell of the numeric HRM and DTM values. Incident command can recall any biotelemetric alarming personnel by sending an “EVAC” recall message signal to the identified monitoring portable device.

For breathing apparatus or SCBA monitoring, the system of the present invention's WPAN module microprocessor (MCU) processes the peripheral air pressure transmitter data received by the integrated ZigBee-type ECI controller from the wireless ZigBee PIN-coded MTASS Air Tank Transmitter. The received air tank pressure data is determined and this pressure value is used to calculate the air consumption rate to determine the remaining air time. The remaining air time (RAT) is a computed projection of the time remaining until the tank pressure reading is zero. Since a direct measure of consumption rate is not available due to the intermittent nature of breathing and to the digital nature of the measured pressure, the rate of consumption is computed from the change of air pressure divided by the time for that change. The most current value of air pressure received is used to comparatively calculate the change in tank pressure from the previously received reading. For as long as the resulting calculations of air pressure readings register over 20 percent of the original air tank volume, the processing proceeds. If the current air pressure registers less than 25 percent of the original air tank volume, a blinking low air pressure message (“LAP”) is displayed on the system of the present invention's LED or LCD display and an audible alarm is activated to alert the user to the low tank pressure. The audible alarm can be deactivated by depressing the side “Reset” buttons. After an alarm condition, activating the “Reset” button feature automatically messages the base station PAMS program with a green “OK” indicator signal on the associated line “recall” button, whereby advising the base station that the alarm condition of the identified wearer has been addressed. Both air pressure and the overriding low air pressure warning message modes are processed through the system of the present invention for telemetry processing over the MANet to display temperature readings on the system of the present invention's software control system dashboard program. Air tank pressure is displayed in remaining pounds per square inch (PSI), air tank time remaining is displayed in minutes and seconds and a non-active SCBA system displays as “OFF” for air PSI and time.

For personnel locator tracking, the system of the present invention MTASS's WPAN module also comprises components with positioning and communication systems to support real-time accountability tracking of and communications with emergency response personnel position and time information via an integrated Global Positioning System (GPS) chip set. The WPAN module's GPS tracker chip set provides longitudinal and latitudinal readings to the MTASS mobile and central command base station console software. The MTASS portable device GPS also provides a satellite monitored locator signal for the MTASS base station command console software to wirelessly connect to the internet via mesh network linkage to access mapping topologies for tracking the location of monitoring MTASS portable devices. Additionally, if the MTASS portable device is configured with a 3G/4G-UMTS/CDMA2000 network module, onboard Assisted Global Positioning System (A-GPS) is another means of MTASS personnel tracking as for indoor scenarios.

The system of the present invention is also multi-functionally integrated, wherein each portable device is equipped with a modular type Wireless Network Interface Card (WNIC) (Module 4), which is network configurable to swap out and reconfigure to function in either WiFi, WiMAX, MBWA, UMTS/CDMA portable wireless mobile network application infrastructures. The portable device Interface Motherboard interface's programmable EEPROM firmware design allows for bios configuration of the type of wireless network card to be used. The WNIC module is powered from the portable device's onboard prismatic Li-Ion rechargeable battery via it's motherboard interface

The system of the present invention MTASS is also multi-functionally integrated, wherein each MTASS portable device has a protective semi-translucent silicone grip band integrated around the MTASS portable device PPSU case siding with open front and back for optimum operational and service functionality. The translucent silicone grip band improves physical handling of the portable device, while also further insulating and protecting from severe shock impact, vibration and heat exposure, without inhibiting LED case illumination.

The system of the present invention is also multi-functionally integrated, wherein each portable device includes a wire clip fitted onto the external surface of the rear panel, configured to securely hold the portable device to a SCBA or rescue harness, or clip to turn-out gear, utility belts, lowering ropes, etc.

The system of the present invention's Personnel Accountability Management System (PAMS) is a software control system that provides network area accountability and situational awareness overview and individual profiling of the twelve telemetry parameters received over a wireless network from any monitoring portable devices. The software control system comprises a graphical user interface (GUI) dashboard-design software program for command and control communications from both onsite and central applications to monitor and log the telemetry broadcasted over a wireless network from each monitoring system of the present invention portable device deployed within the network. Depending upon the wireless network capability, a mobile command base station can monitor up to 55 monitoring portable devices of first responders at one time. When networked to a Wireless Metropolitan or Wide Area Mesh Network or SatCom link, the system of the present invention's PAMS software program has Internet linkage buttons to query local area weather conditions, global positioning system (GPS) mapping of signaling portable devices and other programmable internet link-to-information features.

The system of the present invention MTASS's PAMS software program, which is to be CAD System interfaceable, allows an emergency agency to program the unique PIN codes of each portable device into the PAMS software to display CAD-system downloaded or customized programmed personnel identifications in the Personnel field of the dashboard screen (e.g. PIN-code “0123”=Personnel (CAD Sys.) ID “Sta-17, Eng-23, Seat-03, John Doe”). Upon receiving PIN-coded telemetry transmissions from monitoring portable devices, the PAMS software program interprets, validates/authenticates PIN-codes. Then associates PIN codes with personnel data base records, as with CAD System downloaded records, and subsequently stores and displays the received information, populating dashboard data point parameters. The data points include the accountability and situational awareness parameters of PIN number, Personnel ID, activation status, assignment, SCBA status, motion status, battery status, ambient thermal temp, biometric telemetry (Heart Rate/Dermal Temp), gas detection status, GPS status, of any monitoring portable device within the deployed mobile area network. When any line item category of accountability & situational awareness parameter goes into an alarm mode, the intersecting line-column cell of the identified portable device will flash in color to indicate am alarm status to alert command to view the dashboard screen, query the line item and even message the alarming portable device wearer.

For personnel locator tracking, the system of the present invention MTASS's PAMS software program receives and displays monitored GPS longitude and latitude readings of deployed MTASS portable devices within the incident area. The MTASS PAMS “Map GPS Locations” dashboard button provides incident command with linkage to GPS tracking & satellite topology mapping of deployed assets as targeted signals within the MANet. The GPS topology mapping feature proves most useful in outdoor geographically dispersed incident deployments, as for application in wild-land fires, natural disaster zones, search and rescues or any other wide area disbursement scenarios. The PAMS “RF Tracking” dashboard button provides incident command with the network administrative feature to calculate/triangulate approximate location of selected personnel, as with alarm reading MTASS portable devices, from radio frequency signal measurements received from MANet Access Points which are shown on a plotting graph. In the event of alarm indications of either flanking fires, structural collapse, flash-flood, avalanche awareness, etc., the PAMS software program provides incident command with individual and entire personnel recall ability. From a mobile command base station server, command can transmit a signal to recall individuals or all personnel equipped with monitoring MTASS portable devices within the network. By selecting either individual line item recall buttons or depressing the “ALL” button to globally message all monitoring portable devices for recall, a yellow “sent” indicator displays on the software button and the broadcasted recall message activates a steady tone and flashes “EVAC” on the display of the targeted monitoring portable device(s). Alerted first responder personnel can then acknowledge the command and quite the alarm by pushing the side reset buttons to quiet the alert signal and ping back a green “OK” message that appears on the selected “recall” key(s) of the mobile command base station dashboard software program and, if mesh networked, onto central command.

If an alarm results from a time violation from one of the technology timers, or from error caused by depression of alarm switch, the wearer can suitably cancel any alarm signal by depressing the side reset buttons. After an alarm condition, activating the “Reset” button feature automatically messages the base station PAMS program with an “OK” indicator signal on the associated line “recall” button, whereby advising the base station that the alarm condition of the identified wearer has been addressed. Thus, false alarm conditions resulting in unnecessary initiation of rescue operations are minimized, resulting in more diligent attention to actual emergency situations.

### BRIEF DESCRIPTION OF THE DRAWINGS

The accompanying drawings, which are incorporated in, and constitute a part of, this specification illustrate several embodiments of the invention and together with the description, serve to explain the objects, advantages, and principles of the invention.

FIG. 1. The system of the present inventions' portable device technical functionality block diagram.

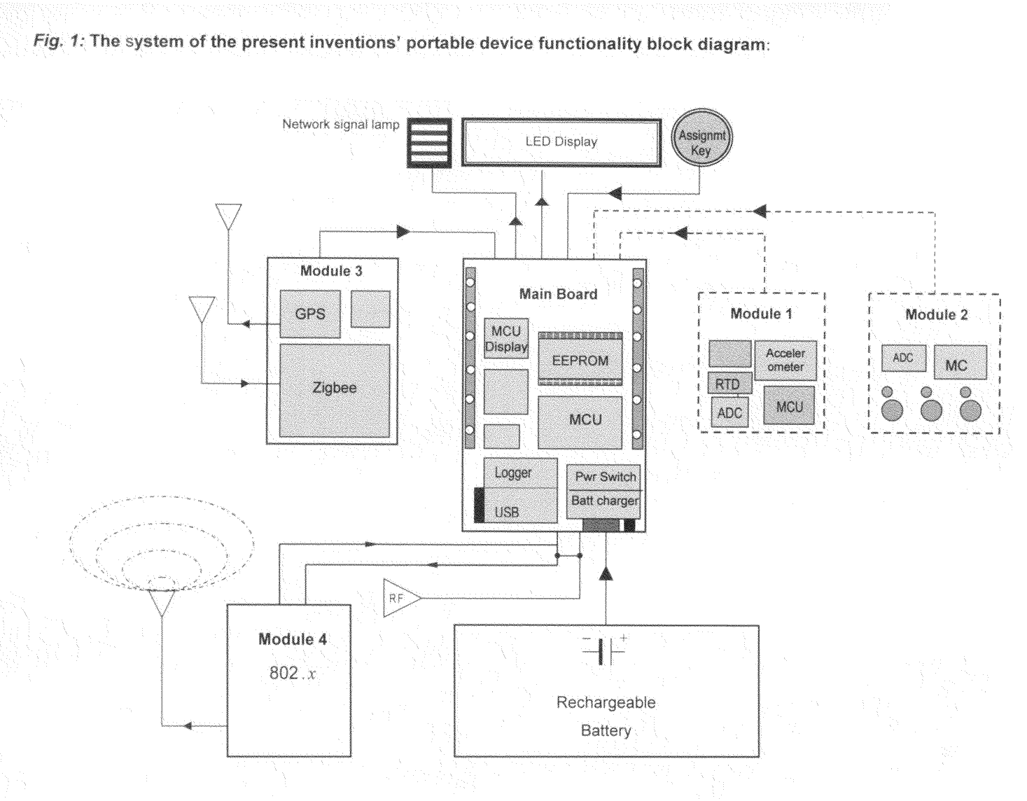

FIG. 2 The system of the present inventions' flow chart block diagram.

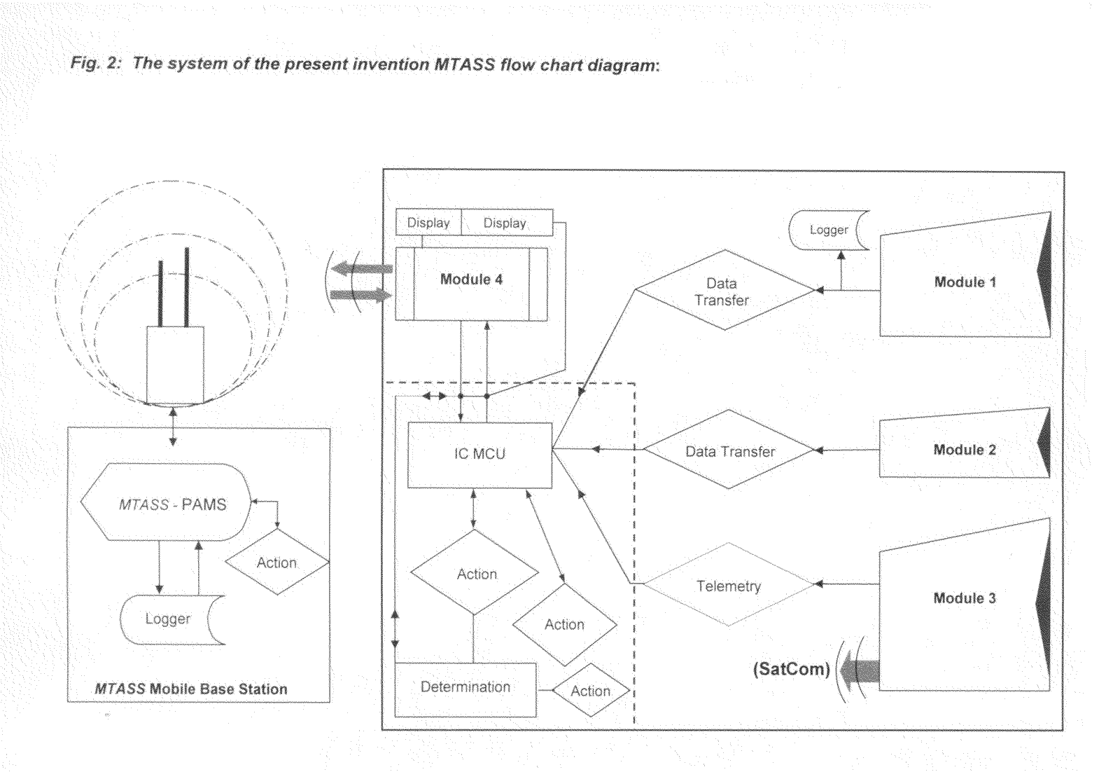

FIG. 3 An illustration of the physical embodiment of the system of the present invention.

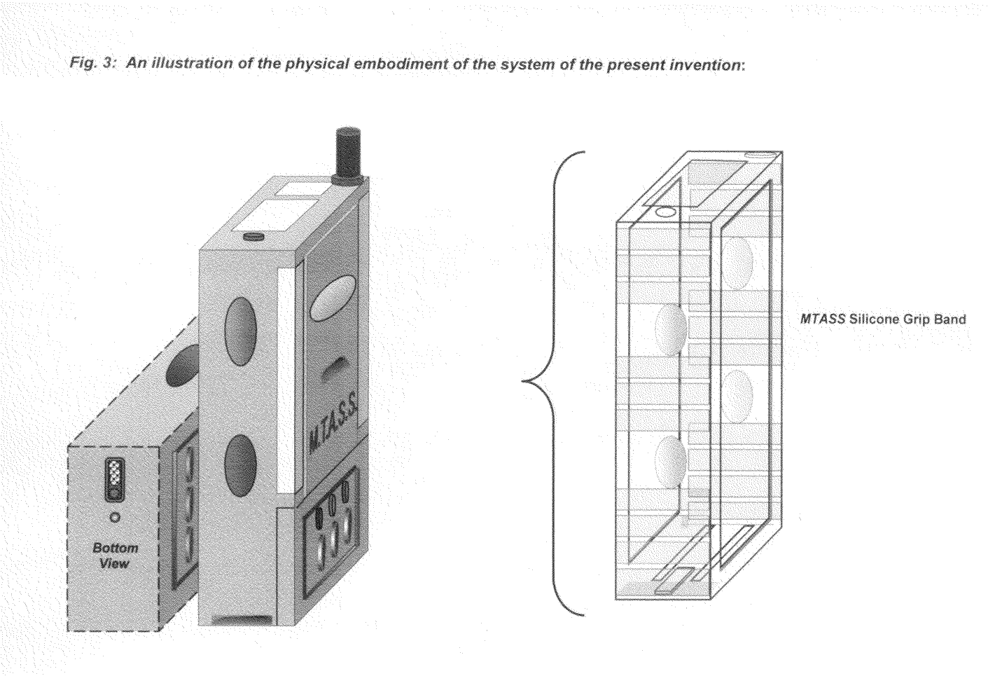

FIG. 4 An illustration of the physical embodiment of the system of the present invention's rear quarter pull-away assembly.

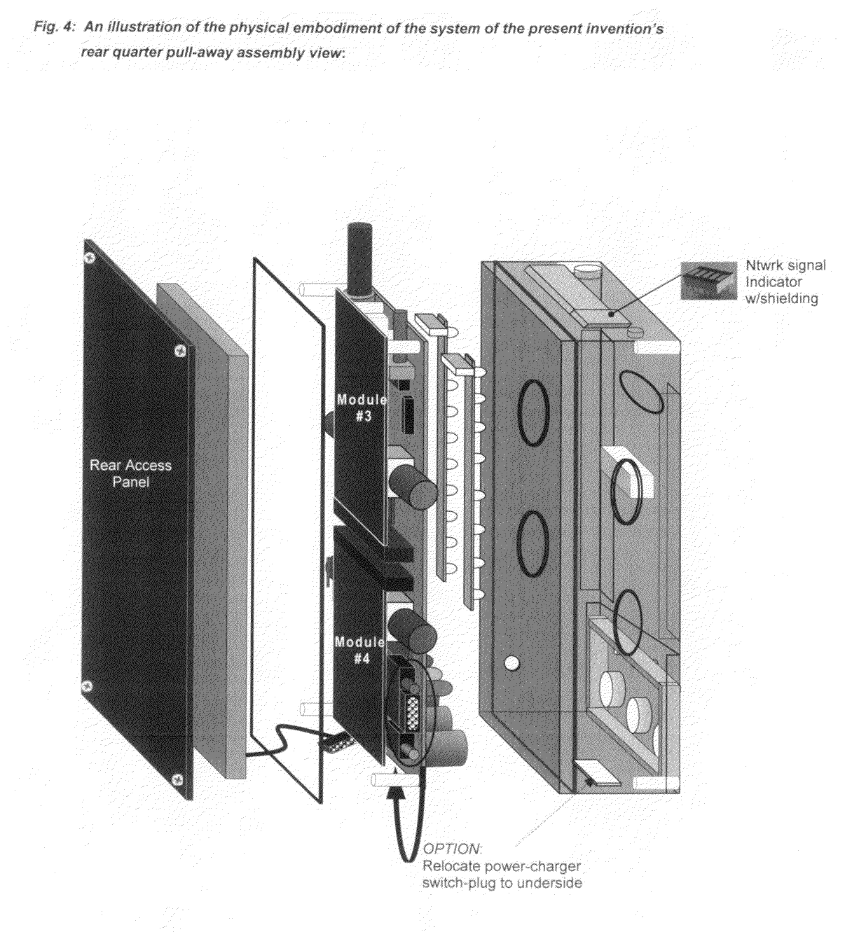

FIG. 5 System of the present invention's Digital LED Display possible functions diagram.

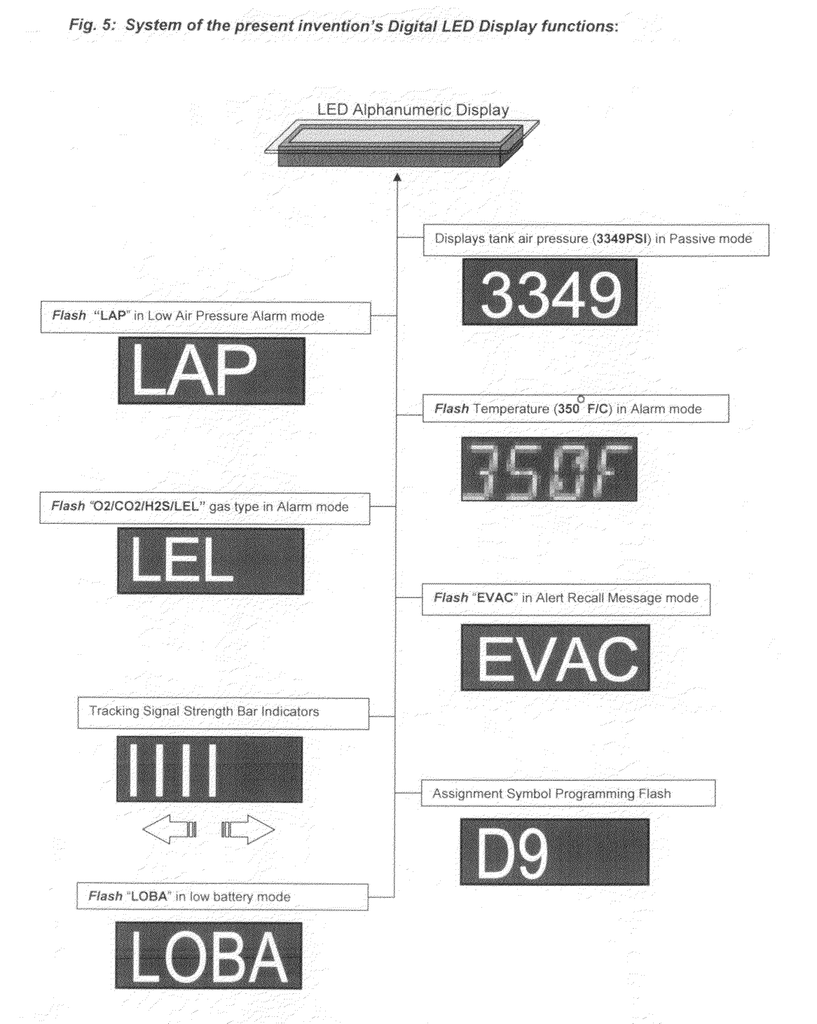

FIG. 6 An illustration of the physical embodiment of the system of the present invention's internal device fully assembled configuration.

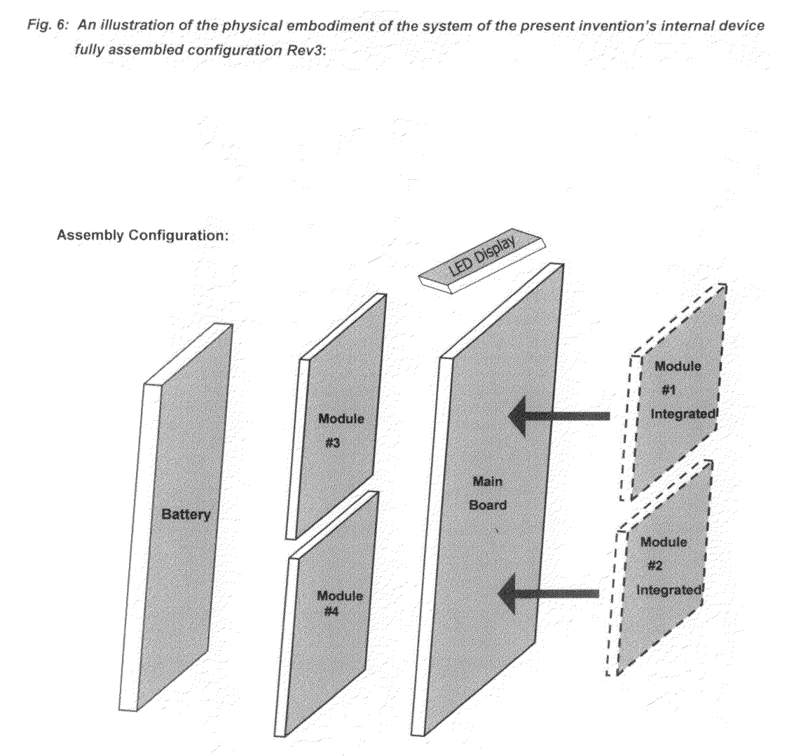

FIG. 7 An illustration of the physical embodiment of the system of the present invention's Wireless Personal Area Network (WPAN) Module (Module #3) and its Wireless Biotelemetry Monitoring Transmitter Peripheral Device.

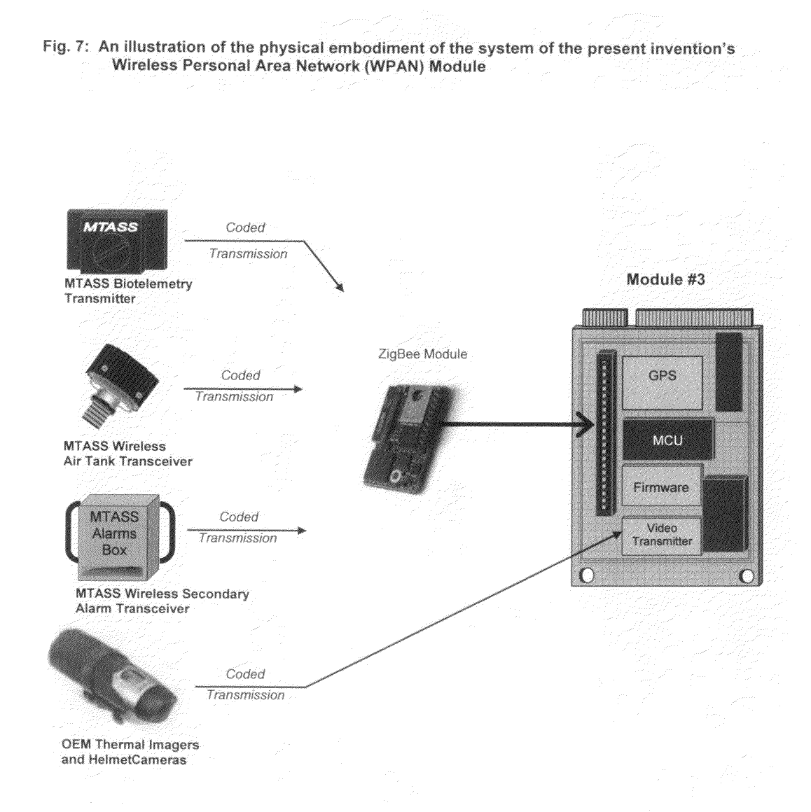

FIG. 8 An illustration of the physical embodiment of the system of the present invention's Wireless Air Tank Transmitter and associated Valve Stem Adaptor.

FIG. 9 An illustration of the physical embodiment of the system of the present invention's Wireless Biotelemetry Monitoring Transmitter Peripheral Device.

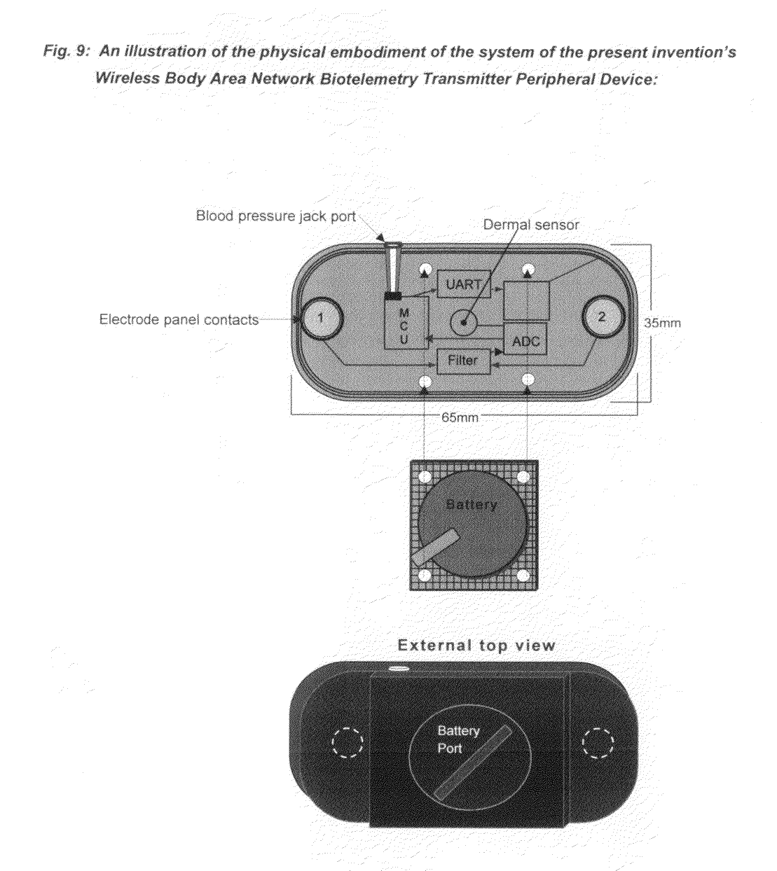

FIG. 10 An illustration of the system of the present invention's Wireless Network Interface Card (Module #4).

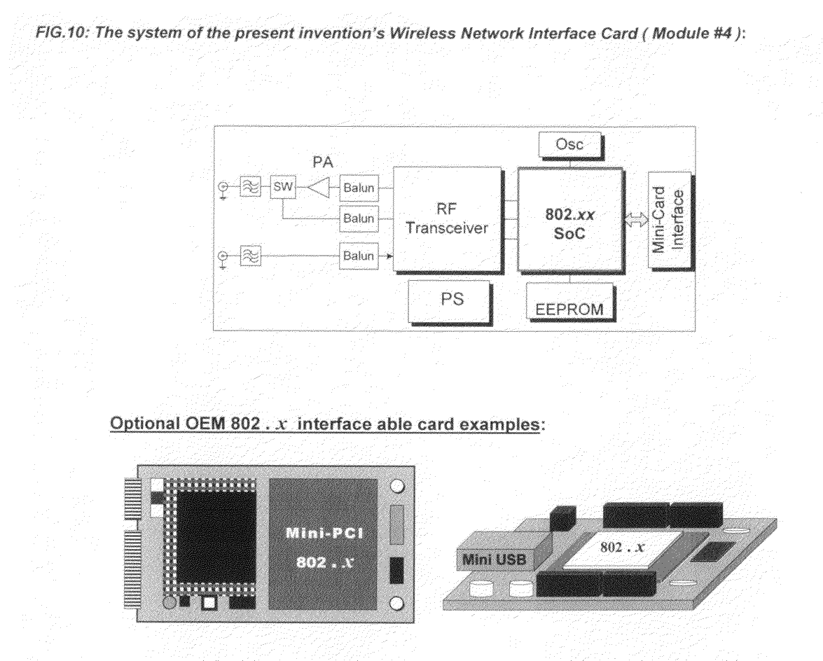

FIG. 11 An illustration of the Personnel Accountability Management Software (PAMS) Program's “Dashboard” design for the system of the present invention's mobile area network base station console monitoring.

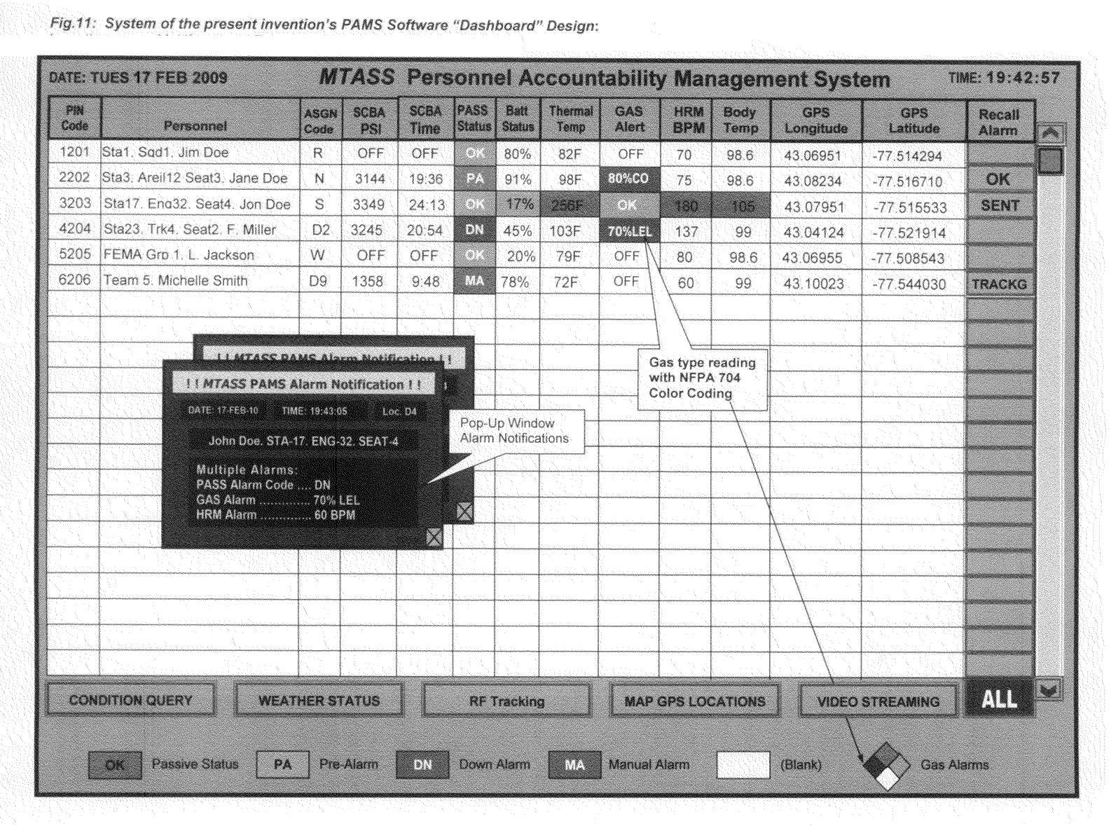

FIG. 12 An illustration of the system of the present invention MTASS Personnel Accountability Management Software (PAMS) program's individual “Condition Query” screen design.

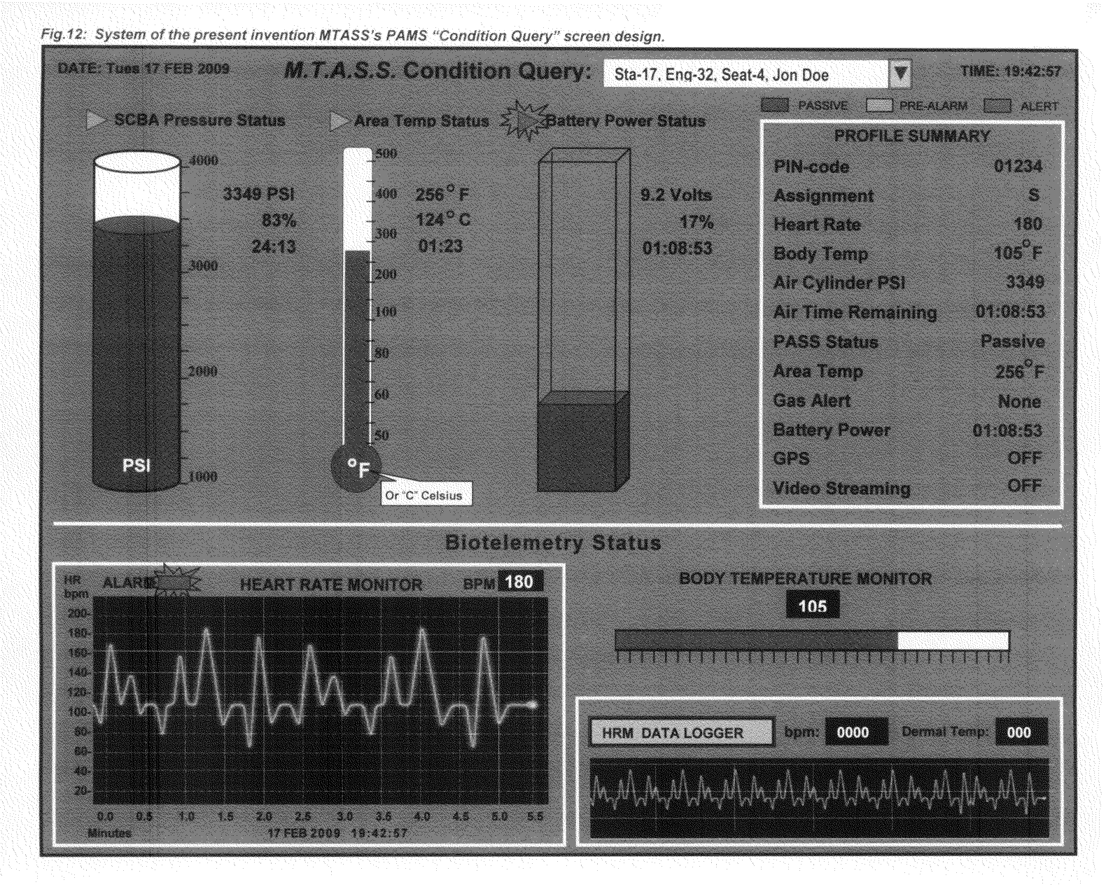

FIG. 13 An illustration of the physical embodiment of the system of the present invention Gas Calibration Kit:

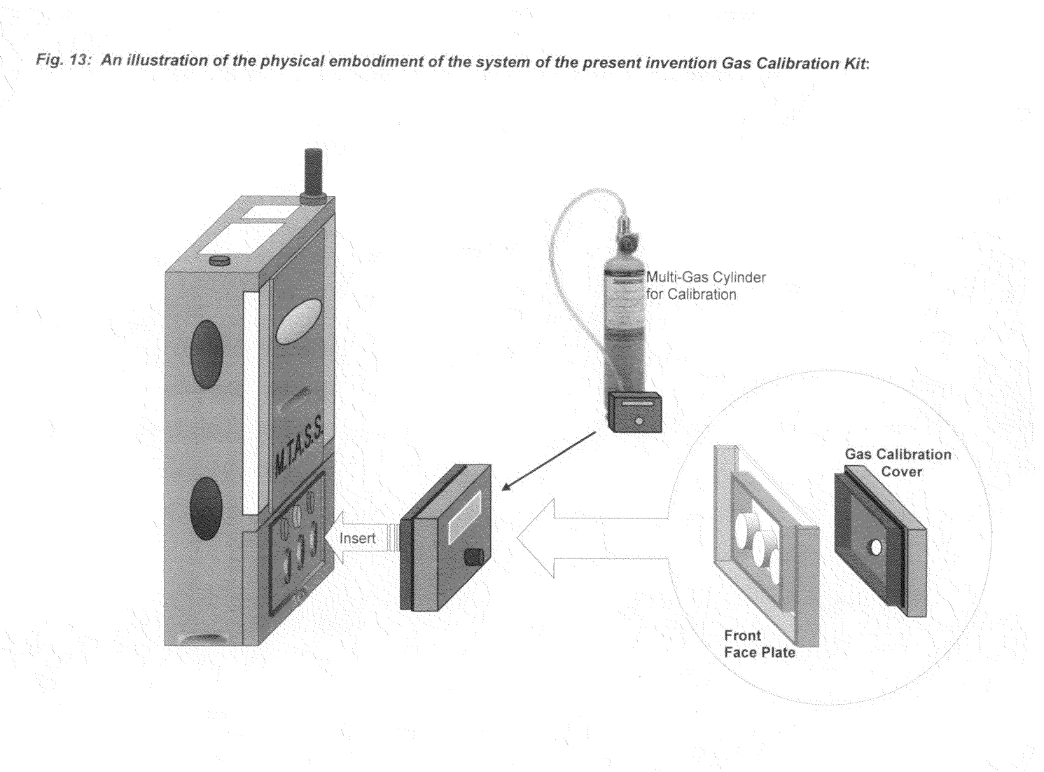

FIG. 14 An illustration of the system of the present inventions' accessory Charger Docking Station Rack & Case

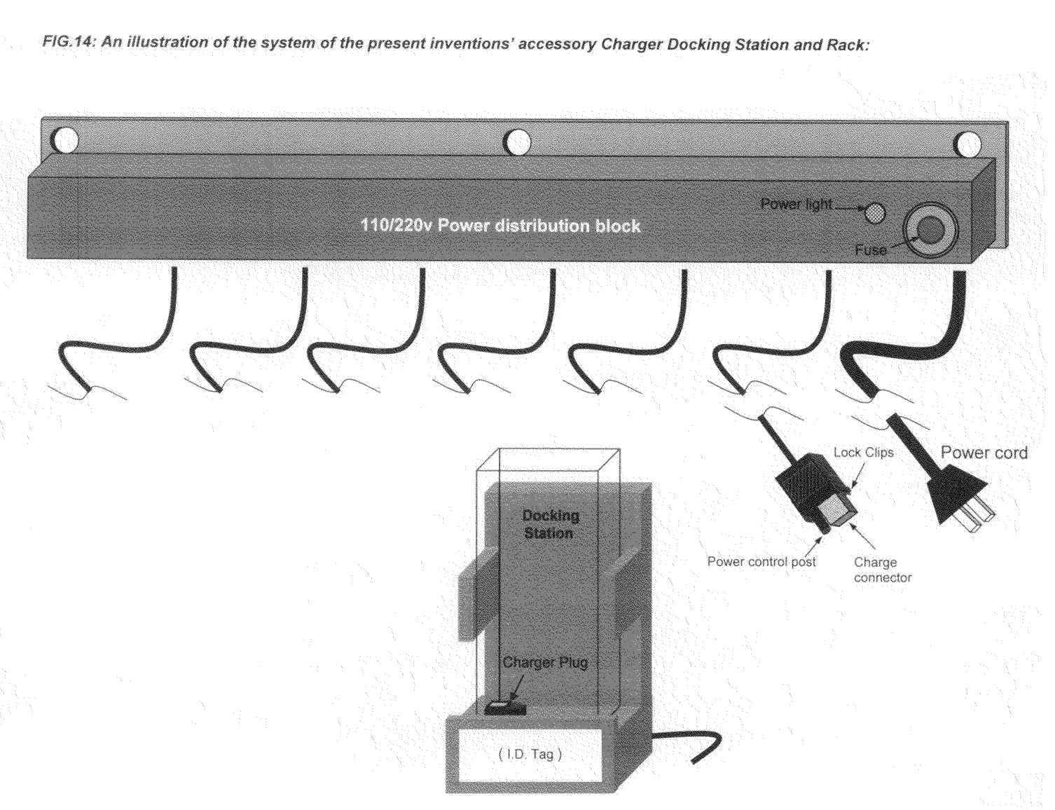

It should be understood that while I have described certain embodiments of the invention, I do not intend to be restricted thereto, but rather intend to cover all variations, improvements and modifications which come within the spirit of the invention, which is limited only by the claims that are appended hereto and by the breadth of interpretation allowed by law.

The embodiments of the invention in which an exclusive property or privilege is claimed as a continuation-in-part (CIP) are defined as follows:

1. The system of the present invention MTASS is unique and advantages to first responders of emergency services or public safety agencies or other dangers/hazardous job workers due to its fourteen integrated wireless network adaptive sensory-telemetry technologies: 1.) personnel accountability identification, 2.) assignment location coding, 3.) heart rate biotelemetry monitoring, 4.) dermal temperature biotelemetry monitoring, 5.) jack-port accommodated blood pressure biotelemetry monitoring capability, 6.) air tank cylinder pressure & air time remaining monitoring & alarming, 7.) multi-gas alert monitoring/sensing & alarming, 8.) motionless alert monitoring & alarming, 9.) ambient temperature monitoring & alarming, 10.) GPS/A-GPS tracking, 11.) RF-motionless/manual alarms tracking, 12.) streaming video transmission capability, 13.) “Evacuation” recall-signal transceiver, 14.) Manual Panic Bar (button) Alarm signaling, all integrated into one singular rugged device, supported by remote software, wireless peripherals, and 802.x network equipment, providing optimum operational safety, improved work efficiency at an increased plurality of desired hazardous worker accountability and situational awareness monitoring during working operations.

2. The system of the present invention MTASS is also unique by its modularity and adaptability of its multi-technology network integration that achieves the following: customizable network adaptation and service modularity to a variety of fixed and mobile IEEE 802 wireless network systems, i.e. IEEE 802.15.4 ZigBee, 802.11a/b/g(n) WiFi, 802.16e WiMAX/WiBRO, 802.20 MBWA, 3G/4G UMTS/CDMA2000, in possible configurations of mini PCI interface type cards, or USB modules, or combo-modules.

3. The system of the present invention MTASS is also unique by way of it's LED network meter signaling display, which displays bars for signal strength. The meter is to be located along side or next to to the system of the present invention's alfa-numeric LED display of the system of the present invention MTASS. The stronger the surrounding network signal, the greater the number of illuminating bars will appear in the meter siganling display while the protable device is in the active or power on state. Subsequently, the weaker the network signal becomes, the fewer the number of illuminating bars will appear in the meter siganling display.

4. The system of the present invention MTASS is also unique in its integrated design of a Wireless Personal Area Network (WPAN) Interface Module. The MTASS WPAN technology is programmable to adaptively integrate with the system of the present invention MTASS's WBAN ZigBee-transmitting peripherals of claims 5 and 6. WBAN peripherals are dedicated by assignment to each MTASS portable device WPAN module by way of unique imbedded PIN-codes 802.15.4 ZigBee transmissions that prevent “cross-talk” between other MTASS peripherals of other nearby portable devices while offering stronger signals of extended range communication compared to that of Bluetooth technology limitations. Each portable device WPAN module's firmware chip set is reprogrammable by way of portable device mini USB or Infra Red (IR) port to computer connectivity and software. MTASS wireless peripheral sensory transmitting devices of claims 5 & 6 not only consist of sensor and data collection technologies but also have a transmitter with a signal emitter generating device which generates an identification signal that is characteristic of the transmitter. This unique numeric or alpha-numeric PIN-code ID of a peripheral's transmitter is programmed into the system of the present invention's WPAN module's bios firmware chip set. The data signal and identification signal are received and tested by a receiver in the portable device's WPAN module. If the identification signal matches (recognized) an identification comparison signal stored in the monitoring portable device via its WPAN programmable firmware, data is accepted and processed through the interface boards controller unit and sent through the wireless network interface module over the local network to base stations that then use the signal to monitor status and locate/track the signal emitter.

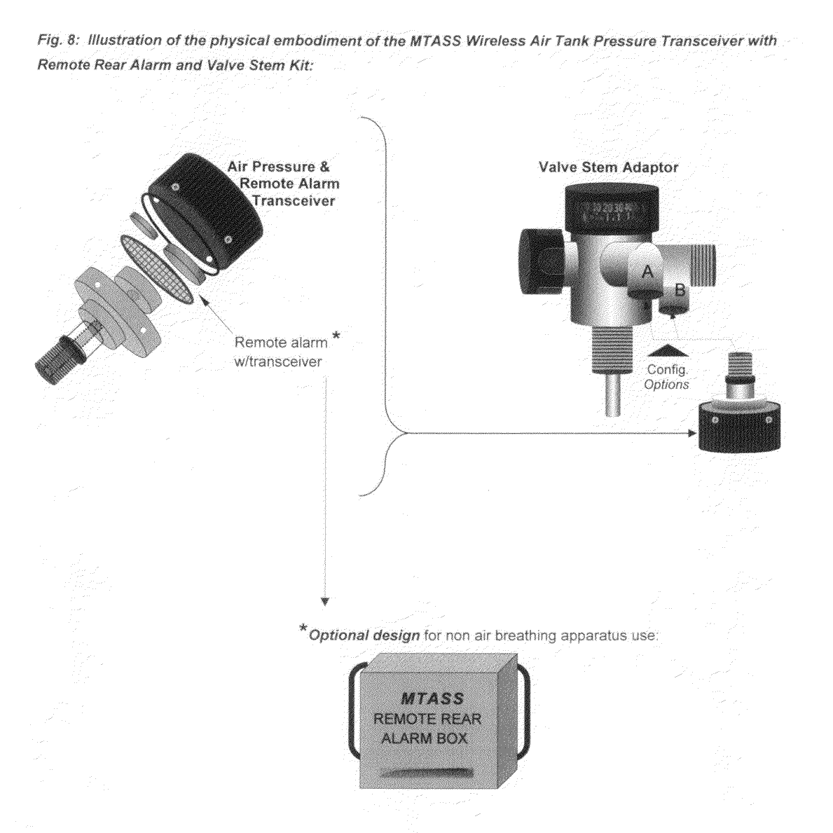

5. The system of the present invention MTASS is also unique by its Wireless Air Tank Transmitter peripheral kit, mentioned in claim one, which comprises a wireless air tank pressure sensing transmitter with audible alarm and adaptable air tank respirator valve stem. The wireless air tank pressure sensing transmitter comprises a pressure sensor to sense and monitor air pressure, audible alarm with receiver that activates when associated portable device enters motionless or manual alarm conditions; 802.15.4 ZigBee transmitter technology to telemetry pressure readings via a unique imbedded PIN-code programmed in for coded transmissions to its associated MTASS portable unit WBAN module technology of claim 4. The unique Air Tank Transmitter consists of a PPSU casing material, as described in claim 7, a metal valve stem platform, integrated pressure sensor, transmitter, 95 dB alarm receiver/emitter, and battery, technologies. The secondary remote alarm feature sits at the top or end of the Wireless Air Tank Transmitter peripheral to receive motionless & manual alarm condition telemetry signals from its associated portable MTASS unit to provide rear-side 95 dB audible alarm signaling in the event the wearer is face down to the ground on top of his/her portable MTASS unit. This wireless remote alarm technology portion maybe designed separately as an independent peripheral device as part of this kit. The unique Air Tank Transmitter & Valve Stem with remote combination Motioinless/Manual Alarm Monitoring peripheral kit is designed to screw into various OEM air tank cylinders either directly or with air tank neck-collar adaptors if the thread size or aperture is different. The kit is to be regulatory agencies certified compliant. When the public safety operator opens the MTASS designed breathing apparatus air tank valve, pressure is sensed by the MTASS wireless air pressure transmitter and is activated to transmit a PIN-coded ZigBee wireless signal to the corresponding PIN-code programmed wireless MTASS portable device's WPAN transceiver. The signal is then processed to the MTASS portable device's main computer board and packaged with other sensory data and transmitted in packet intervals to be received by MTASS mobile base stations operating the MTASS base station software. As part of this same claim 5 of the System of the Present invention MTASS, the wireless rear audible alarm technology of this claim 5 is optionally designed to be provided in a separate, small, clip-on/strap-on box configuration that is to be worn on either the back-side collar, the helmet, the back-side of a harness, backpack, or the rear of the waist belt, if the Air Tank Transmitter technology is not applicable to the System of the Present Invention's user. The wireless Rear Alarm Box Transmitter option consists of a PPSU casing material, as described in claim 7, a metal clip and bar strap design for mounting purposes, and integrated 95 dB audible alarm, receiver, emitter, LED's, battery (which may or may not be rechargeable), and supporting micro electronic and firmware technologies. (See FIG. 8)

6. The biotelemetry mentioned in claim 1, wherein the system of the present invention MTASS is also unique in its addition of a PIN-coded 802.15.4 ZigBee wireless biometric peripheral transmitter device. This peripheral device technology comprises the integration of both a heart rate monitor (HRM) and a dermal (skin) temperature monitor (DTM) into a single wireless ZigBee technology PIN-coded transmitter unit as a peripheral device of the system of the present invention. Plus a jack port maybe incorporated to allow interface with a blood pressure measuring device, where data received through this port will become part of the PIN-coded telemetry interval package. The biotelemetry transmitting unit wirelessly broadcasts biometric telemetry of measured heart rate and dermal (skin) temperature, and possibly blood pressure, as a ZigBee PIN-coded transmission from the peripheral unit to the associated portable device's WPAN interface module for processing to the motherboard interface of the system of the present invention portable device and then broadcasted over a portable wireless mobile network to a mobile command base station(s) running the system of the present invention's GUI dashboard software program to accommodate received telemetry data. The unique PIN-code to each wireless biotelemetry peripheral device is programmed into its associated system of the present invention portable device's WPAN programmable firmware, as described in claim 4, to prevent “cross-talk”between other peripherals of other nearby portable devices. The system of the present invention's wireless biotemetric peripheral transmitter device is designed to interface with OEM biometric garments that have an electrode panel designed into the garment.

7. The system of the present invention MTASS is also unique in its application of a Polyphenylsulfone (PPSU) type casing with a transparent indium-tin-oxide (ITO) heat-resist top shielding over the LED display port areas, combining greater temperature and impact durability, lighter weight, enhanced strength and customized color and translucency as compared to other polymer plastics. The portable device PPSU casing protects the internal technology from exposure to shock, heat, moisture, chemical and other hostile agent exposures. This PPSU material is used for the casing on the peripheral air tank transmitter and biometric transmitter and remote backup alarm unit. The PPSU casing is also protected by a transparent shock and heat protective ‘Silicone Grip Band’ surrounding the outside perimeter casing, custom-molded with grip-blocks elevated along the siding of the griip band. The grip band does not cover the front or the back of the MTASS portable telemetry device casing and provides for drainage slots to leakge moisture that may accumulate between the grip band and protable device casing.

8. The system of the present invention MTASS is also unique in its application of a rechargeable internal prismatic battery design, interfacing with the system technologies and claim 9 being a combination automatic on/off power-charger technology feature function, integrated together.

9. The system of the present invention MTASS is also unique in its application of a combination automatic power and charger plug-switch, wherein each MTASS portable device is automatically powered off whenever the battery charger plug-switch is inserted into an MTASS portable device and automatically powered on whenever the charger plug is removed. This allows for automatic powering on/off while also charging in the “off” mode of the MTASS portable telemetry device. When the combination plug-switch is inserted, the system of the present invention MTASS portable telemetry device simultaneously enters the “Off” (inactive) and “Charging” (battery) modes or condition, thereby returning the unit to the ‘Storage/Charging’ position. When removed from the plug-switch, the system of the present invention MTASS portable telemetry device simultaneously enters the “On” (active) and “Not charging” (battery) modes or condition. The power-charger control plug-switch makes end-to-end contact with both a power pressure switch post to activate the power function of the MTASS portable device and a battery charger connector for interfacing with the charging port of the MTASS portable device. The integrated automatic power-charger port mates up with either the MTASS system fixed wall or vehicle-mounted charging dock or rack station accessories. From the front view of the MTASS portable telemetry device, the power-charger port is located on the lower half (side or bottom) of each unit and protected by a port access flap of the integrated silicone grip band.
